(19) United States
(12) Patent Application Publication
(10) Pub. No.: US 2021/0261016 A1
(43) Pub. Date: Aug. 26, 2021

(54) CHARGING SYSTEM FOR ELECTRIC VEHICLES

(71) Applicant: Ingo Kledewski, Dortmund (DE)

(72) Inventor: Ingo Kledewski, Dortmund (DE)

(73) Assignee: innogy SE, Essen (DE)

(21) Appl. No.: 17/316,958

(22) Filed: May 11, 2021

Related U.S. Application Data
(63) Continuation of application No. PCT/EP2019/077365, filed on Oct. 9, 2019.

(30) Foreign Application Priority Data
Nov. 12, 2018 (DE) 10 2018 128 188.9

(51) Int. Cl. B60L 53/67; B60L 53/66; B60L 53/68; B60L 53/63; B60L 53/62; B60L 53/65

(52) U.S. Cl. CPC B60L 53/67; B60L 53/665; B60L 53/68; B60L 2240/72; B60L 53/62; B60L 53/65; B60L 53/63

(57) ABSTRACT

A charging system for electric vehicles, comprising a plurality of charging stations, at least one memory module at least arranged for storing charging curve characteristics dependent on charging station position, and at least one charging curve determination module adapted to determine a charging curve for charging an electric vehicle connected to a first charging station of the plurality of charging stations based on position information of the first charging station and the stored charging station position-dependent charging curve characteristics.

### CROSS-REFERENCE TO RELATED PATENT APPLICATIONS

This patent application is a continuation of International Application No. PCT/EP2019/077365, filed on Oct. 9, 2019, which claims the benefit of priority to German Patent Application No. 10 2018 128 188.9, filed Nov. 12, 2018, the entire teachings and disclosures of both applications are incorporated herein by reference thereto.

### FIELD OF INVENTION

The application relates to a charging system for electric vehicles comprising a plurality of charging stations. In addition, the application relates to a method for operating a charging system.

### BACKGROUND

Charging systems for charging electric vehicles are known from the prior art. Known charging systems generally comprise a plurality of charging stations, which may be communicatively coupled to a backend system. A charging station may have at least one charging point to which an electric vehicle to be charged can be electrically connected. For example, the charging point may be a charging cable attached to the charging station that may be connected to a charging port of the electric vehicle. Alternatively, the charging point may be a charging port at the charging station that can be connected to a charging cable.

Before the charging process is started, a charging curve for charging the electric vehicle is usually defined. The charging curve represents the time course of the power output (and current output, respectively) to the electric vehicle during the charging process. The definition of the charging curve can depend, for example, on the state of charge of the electrical storage unit (in particular, a traction battery) of the electric vehicle to be charged.

By defining the charging curve before the start of the charging process, the charging controller, in particular, of the electric vehicle, is aware of the electrical power with which the electrical storage unit is charged during the charging process.

In practice, it occurs again and again during charging that a charging process is cancelled (aborted) or not started at all. If a charging process is cancelled (interrupted), a new charging process can usually only be started with the cooperation of the user of the electric vehicle. Since the user is usually not at the electric vehicle when a charging process is cancelled, he or she is often unaware of a charging process (cancellation). This leads to the fact that when the user returns to his electric vehicle, he or she finds that the electric storage unit has not been charged or has been charged incompletely, contrary to his or her planning.

### BRIEF SUMMARY OF THE INVENTION

Therefore, the object of the application is to provide a charging system in which a charging process is carried out with increased reliability.

According to a first aspect, the object is solved by a charging system for electric vehicles according to claim 1. The charging system comprises a plurality of charging stations. The charging system comprises at least one memory module. The memory module is at least configured to store configured to store charging station position dependent charging curve characteristics. The charging system comprises at least one charging curve determination module. The charging curve determination module is configured to determine a charging curve for charging an electric vehicle connected to a first charging station of the plurality of charging stations at least based on position information of the first charging station and the stored charging station position dependent charging curve characteristics (in particular, the at least one charging curve characteristic stored for the charging station position of the first charging station).

In contrast to the prior art, the reliability of the charging processes is increased in the charging system according to the application in that a charging curve is determinable which is optimized at least with respect to the charging station position. In particular, the number of cancelled charging processes can be reduced by the charging system according to the application.

The charging system according to the application comprises a plurality of charging stations. A charging station according to the application is meant to be a stationary device that allows the exchange of electrical energy between an electric vehicle and the electrical storage of the electric vehicle, respectively, and the device. In particular, a charging station comprises at least one charging point in order to couple an electric vehicle to the charging station, for example, via a charging cable, so that electrical energy can be exchanged via the charging cable.

Further, the charging station may comprise charging technology in order to control the charging process. As a charging point, a charging station may have at least one fixedly attached charging cable and/or at least one charging port that may be coupled to a charging cable.

The charging stations are located at different places and positions, respectively, in particular, in public as well as in partly public areas.

In the present context, an electric vehicle is to be understood as a vehicle, in particular, a car, which can be operated at least partially electrically and comprises at least one rechargeable electrical storage unit, in particular, a traction battery.

Furthermore, the charging system comprises at least one memory module. The memory module may be arranged and implemented, respectively, in the charging station, a backend system of the charging system, and/or a storage arrangement controlled, for example, by the backend system. The memory module preferably stores a plurality of charging curve characteristics for the plurality of charging stations.

A charging curve characteristic according to the application is at least one charging curve characteristic specific to a charging station position. Preferably, at least one charging curve characteristic can be stored for each of a plurality of charging stations that is specific to the position and location, respectively, of the charging station. The position may be available to the charging curve determination module in the form of a charging station position information. A charging curve characteristic according to the present application represents at least one charging curve information that enables a determination of a charging curve optimized for the charging station position. In one case, a charging curve specified for the charging station position is provided as a charging curve characteristic specific to the charging station position.

Thus, according to the application, it has been recognized that at least one reason for a cancellation of a charging process is the specific power grid environment of a charging station. In particular, there may be grid position specific interference factors in the area of the installation site and position, respectively, of the charging station. For example, a charging station may be located at a (power grid) position in whose (immediate) grid environment at least one electrical consumer and/or at least one electrical producer is/are located. By way of example, a switching operation by the producer and/or consumer may cause a disturbance in the power grid, which in turn may cause a temporary change in the power (or current, voltage or frequency) delivered to the electric vehicle.

In the prior art, such a change regularly leads to an abortion of the charging process. The reason for this is that a charging control device, in particular, of the electric vehicle, causes the charging process to be cancelled for safety reasons if there is a specific minimum deviation between the previously agreed charging curve and the actual power and current flow, respectively.

The interference factors occurring at a charging station are therefore—at least also—dependent on the respective network position of the charging station. The at least one grid position-specific disturbance factor of a charging station is mapped and taken into account, respectively, in the at least one charging station position dependent charging curve characteristic (in one case a charging curve) for this charging station.

In other words, the at least one charging station position specific and network position specific, respectively, charging curve characteristic ensures that locally occurring disturbances in the neighboring power grid of a particular charging station are already taken into account when determining the charging curve to be used at this particular charging station, so that, in particular, a cancellation of a charging process due to a local disturbance occurring, for example, regularly in this area can be avoided.

Preferably, each charging station may have a communication link to the charging curve determination module. The charging curve determination module may be arranged in the charging station, a backend system of the charging system and/or a separate computing device controlled, for example, by the backend system.

In particular, prior to the start of a charging process, a charging curve may be determined for the respective charging station, for example, upon a detection of a charging request signal or a similar charging process start signal. In particular, the charging station position of preferably each charging station may be known in advance to the charging curve determination module. Alternatively or additionally, the charging station can communicate its position data to the charging curve determination module in the form of position information or the position data can be derived from a charging station identifier. With the position data and the position information, respectively, the position, in particular, the power grid position of the charging station, is uniquely identified at least in the charging system.

In addition, the stored charging station position dependent charging curve characteristics are searchable, in particular, by the respective position information in the memory module. Thus, in particular, it can be provided that the charging curve determination module determines, based on a received position information and a received position data set, respectively, of a charging station at which a charging process is to be carried out, the at least one charging curve characteristic associated with the charging station and, based on this at least one charging curve characteristic, determines the charging curve to be used.

In other words, based on the charging station position, the at least one charging curve characteristic may be determined (by searching the memory module), and then the charging curve may be determined based on the at least one determined charging curve characteristic. In one case, the determined charging curve characteristic may be the charging curve.

It shall be understood that when a charging station is initially put into operation, no charging curve characteristics or default charging curve characteristics may be stored for that charging station, wherein charging curve characteristics specific to the charging station position may be stored and/or optimized by a teach-in process described hereinafter.

According to a first embodiment of the charging system according to the application, the stored charging curve characteristics may be vehicle type dependent. The charging curve determination module may be configured to determine the charging curve at least based on the vehicle type of the connected electric vehicle. Thus, it has been recognized that a further reason for the cancellation of charging processes may be the charging control devices (in particular, the rectifier) installed on the vehicle side, which may react differently to a disturbance in the transmitted power and current, respectively. While in a first type of vehicle a first disturbance may lead to a charging process cancellation, but another disturbance may not, this may be different in a second type of vehicle.

Preferably, the memory module may be configured to store vehicle type dependent and charging station position dependent charging curve characteristics. The charging curve determination module may be configured to determine a charging curve for charging an electric vehicle connected to a first charging station of the plurality of charging stations based on the vehicle type of the connected electric vehicle, position information of the first charging station, and the stored charging curve characteristics. In particular, based on the vehicle type and the position information, the at least one charging curve characteristic can be determined (by searching the memory module accordingly). Subsequently, the charging curve may be determined based on the at least one charging curve characteristic. In one case, the determined charging curve characteristic may be the charging curve to be used.

According to a further embodiment of the charging system according to the application, at least one charging curve characteristic may define a positive charging curve range. In the present case, a positive charging curve range means, in particular, that if a charging curve lies in this range, it can be assumed with a high probability (e.g. >90%, preferably greater than 95%, in particular preferably >98%) that the charging process will be successful, i.e. will not be interrupted. The charging curve determination module can determine the charging curve based on the at least one charging curve characteristic such that the determined charging curve lies within the defined positive charging curve range.

As has already been described, in one case, a charging curve may be stored in the memory module as a charging station position dependent charging curve characteristic, in particular, as a vehicle type dependent and charging station position dependent charging curve characteristic. In this case, determining the charging curve comprises searching the memory module for the charging curve stored for the particular vehicle type and the particular charging station position.

Preferably, in order to define the positive charging curve range, the at least one charging curve characteristic may be a positive support point or a negative support point. In particular, a plurality of positive support points and/or negative support points may be provided as charging curve characteristics. In particular, a positive support point may specify a point (e.g., a permissible power value at a particular time point or time range) or a range (e.g., a permissible power value range at a particular time point or time range) through which a charging curve to be used must pass.

In particular, a negative support point can specify a point (e.g., an impermissible power value at a particular time point or time range) or a range (e.g., an impermissible power value range at a particular time point or time range) that a charging curve must not pass. By specifying support points, the charging curve can be determined with specific degrees of freedom, which, for example, allow the charging curve to be modified according to current environmental conditions within the positive charging curve range defined by the support points, as will be discussed in more detail below.

Further, in order to define the positive charging curve range, the at least one charging curve characteristic can be a positive (limit) charging curve or a negative (limit) charging curve. In particular, two limit charging curves can be used to define the positive charging curve region in which a charging curve to be used must be located. Also in this case, the charging curve can be determined with specific degrees of freedom, as described above.

As has already been described above, the memory module may be searchable by the charging curve determination module. According to a further embodiment of the charging system according to the application, the charging curve characteristics may be stored in a database of the memory module, wherein the database is searchable at least by position information and charging station position, respectively, preferably by charging station position and vehicle type. In particular, a multi-dimensional lookup table can be provided in which the charging station position dependent and, in particular, vehicle type dependent charging curve characteristics are stored in such a way that they are searchable by position information and, in particular, by vehicle type. In a simple manner and, in particular, in an efficient manner, the at least one charging curve characteristic can first be determined for a specific charging station (position) and, in particular, the vehicle type of the vehicle to be charged. Subsequently, a charging curve can be generated based on this.

The stored charging curve characteristics that are dependent on the charging station position and, in particular, on the vehicle type can be determined, for example, by means of simulations or tests before a charging station is put into operation and stored in the memory module.

According to a particularly preferred embodiment, the stored charging station position dependent and, in particular, vehicle type dependent charging curve characteristics can be based on historical charging processes. In particular, this can provide a self-learning charging system that can be continuously improved and, in particular, automatically adapted to changes in the surrounding power grid or changes in a vehicle type.

Preferably, the charging system can comprise at least one recording module. The recording module may be arranged in the charging station, a backend system of the charging system, and/or a separate computing device controlled, for example, by the backend system. The recording module may be configured to record charging processes at the plurality of charging stations. In particular, the at least one recording module can record (almost) every charging process, for example, with the help of suitable measurement sensors.

The charging system may comprise at least one evaluation module. The evaluation module, which may communicate with the recording module, may be arranged in the charging station, a backend system of the charging system, and/or a separate computing device controlled, for example, by the backend system. The evaluation module may at least be configured for a charging station position specific evaluation, preferably for a charging station position specific and vehicle type specific evaluation, of the recorded charging processes. Based on the charging station position specific evaluation, the charging curve characteristics can be stored in the memory module.

Preferably, the evaluation module can be configured to detect a successful charging process, wherein based on the detection of a successful charging process, in particular, positive charging curve characteristics can be stored in the memory module. Alternatively or additionally, the evaluation module can be configured to detect a cancelled charging process, wherein negative charging curve characteristics can, in particular, be stored in the memory module based on the detection of a cancelled charging process. A cancelled charging process is, in particular, also understood to mean a charging process that is not started.

The charging curve characteristics can preferably be generated with the aid of a data evaluation of a plurality of charging processes. In particular, a computing unit in the backend system can be used as an evaluation module to analyze a plurality of charging processes that have been carried out and, in particular, in the case of successfully completed charging processes (i.e., those that have not been cancelled), to generate common (positive) characteristics of the used charging curves (hereinafter referred to as positive characteristics). These positive characteristics can be stored in the form of the previously described (positive) support points (or limit charging curves) and/or used to determine the previously described (positive) support points (or limit charging curves), which can then be stored. This can also be used to further optimize already existing characteristics.

Characteristics can be, in particular, charging power level at a charging curve, charging voltage level at a charging curve, charging current level at a charging curve, voltage increases at a charging curve, current increases at a charging curve, but also number of negotiations between the electric vehicle and the charging station.

Preferably, the unsuccessfully performed charging processes, in particular, cancelled or non-started charging processes, can additionally be evaluated, in particular, with regard to common (negative) characteristics of the charging curves. If common (negative) characteristics of the charging curves are determined in this process, these (negative) characteristics can be stored in the form of the previously described (negative) support points (or limit charging curves) and/or used to determine the previously described (negative) support points (or limit charging curves), which can then be stored. In operation, a charging curve can then be determined by the charging curve determination module based on this historical data, as previously described.

Alternatively or additionally, it may be possible for charging curve characteristics to be created and stored manually or semi-automatically by a charging station operator and/or a backend provider as a result of a problem that has occurred with regard to a particular charging station position and, in particular, with regard to a particular vehicle type. If, for example, there are relatively frequent problems when charging a particular vehicle type, so that a charging process cannot be completed successfully, at least one charging curve characteristic can be determined for the particular vehicle type, for example, for which (almost) no problems occur.

This search for a working charging curve can, for example, be performed heuristically by a computing device, for example, by an artificial intelligence (AI) trained there, or by a person. This at least one charging curve characteristic (for example, a charging curve) can be stored in the database for the vehicle type. When a desired charging process is performed with the particular vehicle type, the charging curve stored in the database can now be used. Advantageously, this makes it possible to prevent charging processes in which problems occur.

According to a further embodiment of the charging system according to the application, the charging system may comprise at least one vehicle type determination module. The vehicle type determination module may be arranged in the charging station, a backend system of the charging system, and/or a separate computing device controlled by, for example, the backend system. The vehicle type determination module may be configured to determine the vehicle type of the electric vehicle connected to the first charging station.

The determining may be based, in particular, on at least one of the following operations/criteria:
a user identifier and at least one user data set associated with the user identifier (wherein the user data set comprises the vehicle type),
a user identifier and at least one previous charging process data set associated with the user identifier (wherein the charging process data set comprises the vehicle type),
a vehicle type information provided by the electric vehicle, and/or
(an evaluation of) a vehicle type information input via a user interface module (of the charging station).

The vehicle type determination can be carried out, for example, by displaying different selection options (vehicle types) to the user on a graphical user interface (for example, on a display at a charging station or on a mobile terminal, such as a smartphone). The different selection options can be determined on the basis of the data stored for a user or a (unique) user ID, for example, his contract data and/or a user account, or the historical data of the user, in particular, the previous charging processes. Thus, it may normally be provided that a user wishes to charge his own vehicle. It is equally conceivable that a user has only rent the electric vehicle.

Alternatively or additionally, it may be possible that the electric vehicle can be identified autonomously by means of an integrated identification means at the charging station.

According to a preferred embodiment, the stored charging curve characteristics can be (day-) time dependent. The charging curve determination module may be configured to determine the charging curve at least based on a charging start time. In other words, the determination of a charging curve may be dependent on when (e.g., on which day of the week and at which time of day) a charging process is started (and, in particular, how long it will take).

For example, due to a recurring event, such as a switching signal in the power grid, e.g., a switching on or a switching off of a street light, there may be problems with a charging process during a specific time range. Such recurring events may be taken into account for charging station position dependent and (day-) time dependent and preferably vehicle type dependent charging curve characteristics.

For example, if a tram passing near a charging station causes the grid voltage and also the charging voltage to rise briefly, then this event of the passing tram can be taken into account in advance and a slightly reduced charging voltage, preferably a charging voltage reduced to 0 V, can be stored in the charging station position dependent and (day-) time dependent and preferably vehicle type dependent charging curve characteristics. The slightly reduced charging voltage can be selected in such a way that a brief increase in the charging voltage does not lead to a charging process cancellation due to an overvoltage.

According to a further embodiment, the stored charging curve characteristics may be dependent on a charging equipment used during the charging process. Exemplary and non-exhaustive charging equipment comprises charging cables and charging cable adapters. The charging curve determination module may be configured to determine the charging curve based at least on the charging equipment used during the charging process.

In particular, it has been recognized that also a charging equipment may have an influence on the success of a charging process. For example, different pieces of charging equipment (e.g., different charging cables) can introduce different disturbance variables. For example, a piece of charging equipment may have an inductance that can change an AC signal at a charging socket of the electric vehicle in such a way that a rectifier present in the electric vehicle does not initiate the charging process or cancels it due to a detected overvoltage.

Preferably, the information about a used charging equipment can be determined in the context of an authentication of a user at the beginning of the charging process. Thus, a user can authenticate himself at a charging station at the beginning of the charging process. Here, it can be queried whether a charging equipment, and if so, which, is being used. This allows this information to be provided to the charging curve determination module. It shall be understood that an automatic detection may also be possible (if, for example, the charging cable has an appropriate identification means or identifier means). The reliability of charging processes can be further improved.

According to a further preferred embodiment of the charging system according to the application, the charging system may comprise a curve adaptation module. The curve adaptation module may be arranged in the charging station, a backend system of the charging system, and/or a separate computing device controlled, for example, by the backend system. The curve adaptation module may be configured to adapt a particular charging curve based on at least one real-time information. In particular, an adaptation, i.e., a change in the charging power level at a charging curve, the charging voltage level at a charging curve, the charging current level at a charging curve, a voltage increase at a charging curve, and/or a current increase at a charging curve, may be carried out within the defined positive charging curve range.

The at least one real-time information may be selected from the group comprising:
a power grid parameter,
a meteorological parameter,
a status information of the connected electric vehicle,
a status information of the first charging station.

It shall be understood that only one of said real-time information or also two or more of said real-time information may be considered in the modification.

A current and instantaneous, respectively, real-time information may be, for example, a grid parameter of the power grid. A grid parameter may be, for example, a grid frequency, a harmonic, a voltage, and/or a current. The at least one grid parameter can be detected by a measuring device and can be made available to the curve adaptation module. It is equally possible that the measuring device is arranged within a charging station. By taking a grid parameter into account, the current grid status can be taken into account and the grid can be stabilized thereby, for example.

A current real-time information can be an information about the current weather situation, in particular, the temperature. For example, if it is very cold or very warm, problems may occur when charging a battery of an electric vehicle, which do not occur at room temperature. For example, the maximum possible charging power must be limited on very warm days.

Also, a current real-time information can be a status information of the electric vehicle to be charged, in particular, a state of charge of the electric vehicle and/or an operating temperature of the electric vehicle. Such a status information can be transmitted by the electric vehicle to a charging station and to the curve adaptation module, respectively, at the beginning of the charging process. For example, the charging station may likewise determine such a status information.

Further, a current real-time information may be a status information of a charging station, such as the available electric power or the operating temperature.

A further aspect of the application is a method for operating a charging system, in particular, a previously described charging system, wherein the charging system comprises a plurality of charging stations and at least one memory module in which (optionally vehicle type dependent and) charging station position dependent charging curve characteristics are stored, the method comprising:
determining a charging curve for charging an electric vehicle connected to a first charging station of the plurality of charging stations based on position information of the first charging station and the stored charging curve characteristics.

Preferably, the determination may additionally be based on the vehicle type of the connected electric vehicle.

It shall be understood that the modules and devices described above may be/are each formed at least in part by hardware elements and/or software elements.

The features of the charging systems and methods can be freely combined with each other. In particular, features of the description and/or the dependent claims can be independently inventive, even by completely or partially bypassing features of the independent claims, in sole position or freely combined with each other.

### BRIEF DESCRIPTION OF THE FIGURES

There is now a plurality of possibilities for designing and further developing the charging system according to the application and the method according to the application. In this regard, reference is made on the one hand to the patent claims subordinate to the independent patent claims, and on the other hand to the description of embodiments in connection with the drawing. The drawing shows:

FIG. 1 a schematic view of an embodiment of a charging system according to the present application,

FIG. 2 a schematic view of a further embodiment of a charging system according to the present application,

FIG. 3 a diagram showing an exemplary charging curve according to the present application, and

FIG. 4 a diagram of an embodiment of a method according to the present application.

In the following, similar reference signs are used for similar elements.

### DETAILED DESCRIPTION

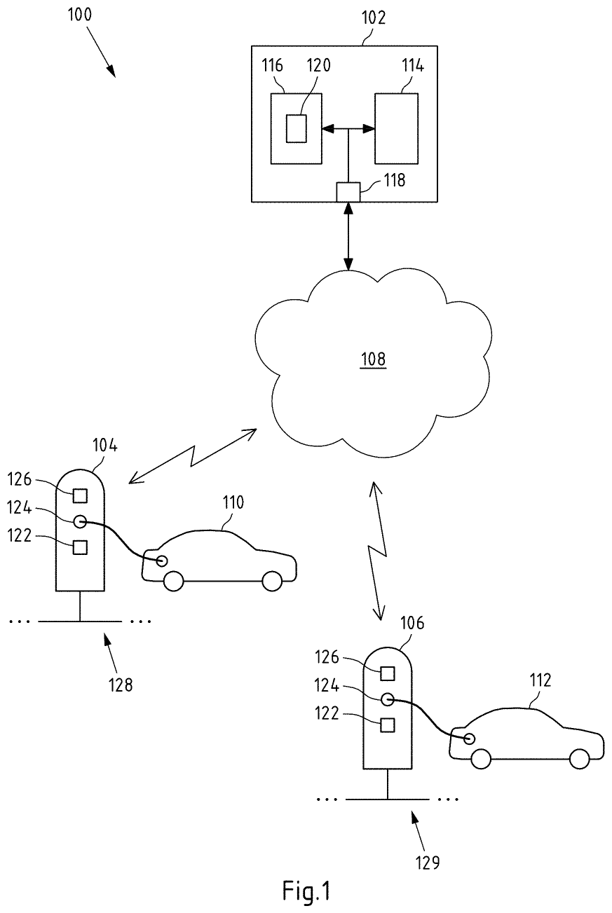

FIG. 1 shows a schematic view of an embodiment of a charging system 100 according to the present application. In the present case, the charging system 100 comprises a plurality of charging stations 104, 106, a memory module 116 and a charging curve determination module 114. In the present case, two charging stations 104, 106 are shown by way of example. It shall be understood that three or more charging stations may be provided in other variants of the application.

In the present example, the memory module 116 and the charging curve determination module 114 are arranged and implemented, respectively, in a backend system 102. Again, it shall be understood that in other variants of the application, at least one of these modules may also be arranged and implemented, respectively, in a charging station.

As can be seen, the charging stations 104, 106 are connected to the backend system 102 (e.g., one or more servers) via a (wireless and/or wired) communication network 108. For communication, the respective elements 102, 104, 106 may comprise suitable communication modules 118, 126.

Each charging station 104, 106 comprises at least one charging point 124, for example, in the form of a fixedly attached charging cable, and a charging controller 122. Each charging station 104, 106 is configured to exchange electrical power with a connected electric vehicle 110 in the course of a charging process. In particular, a charging station 104, 106 may deliver electrical power to an electric vehicle 110 for charging a vehicle battery. Each charging station 104, 106 obtains the deliverable electrical energy and power, respectively, from a power grid 128, 129, in particular, a power supply grid 128, 129. A charging controller (not shown), in particular, comprising a rectifier, may also be arranged in the electric vehicle 110.

The exemplary charging stations 104, 106 are arranged at remotely located positions, in particular, power grid positions. In other words, the power grid environment 128, in particular, the producers and/or consumers (not shown) arranged adjacent to a first charging station 104, may be different compared to the power grid environment 129, in particular, the producers and/or consumers (not shown) arranged adjacent to the (further) charging station 106. In particular, different power grid environments may cause different interference factors (for example, due to switching operations) that could yield to a cancellation of the charging process.

According to the application, the number of cancellations (aborts) can at least be reduced by basing the generation of a charging curve for charging an electric vehicle 110 at a particular charging station on at least one charging station position dependent charging curve characteristics. The charging curve represents the time course of the power output (and/or voltage course and/or current course) to the electric vehicle 110 during the charging process.

For example, when an electric vehicle 110 is connected to a first charging station 104 in order to start a charging process, this may be detected in a known manner by the charging control device 122 of the first charging station 104. Thereupon, a charging curve for the charging process may be determined by the charging curve determination module 114.

To this end, for example, a corresponding request may be transmitted to the charging curve determination module 114 by the first charging station 104, wherein the request may comprise, for example, a charging station identifier (e.g., signature, unique address, unique code, etc.) or a position information, such as a charging station position data set of the charging station 104. Preferably, the request may further comprise an information (e.g., the user ID and/or an explicit vehicle type information) from which the vehicle type of the electric vehicle 110 to be charged may be at least derivable.

In addition, further data may be included in the request, such as a time specification and/or a specification about any used charging equipment.

In particular, in order to determine the charging curve to be used, the charging curve determination module 114 may access the memory module 116 and search a database 120 implemented therein, in which a plurality of charging station position dependent charging curve characteristics are stored for the plurality of charging stations. Preferably, the database 120 may be formed in the form of a lookup table that allows at least a searching of the table depending on the position information and charging station position, respectively, of the respective charging station 104, 106. Preferably, it may additionally be possible to search the table as a function of the vehicle type, the current time (e.g., day of week plus time of day) and/or a used charging equipment.

Based on the information included in the request, in particular, based on the position information of the first charging station 104, the charging curve determination module 114 determines the at least one charging curve characteristic by searching for charging curve characteristics specific to the first charging station 104, i.e., dependent on the position information.

By way of example, it is assumed herein that the at least one charging curve characteristic is (already) a charging curve. Once the charging curve has been determined, it can be transmitted to the first charging station 104 and subsequently used for the charging process with the connected electric vehicle 110.

Since the provided charging curve takes into account the particularities of at least the grid environment of the charging station 104, preferably also the particularities of the vehicle type of the electric vehicle 110 to be charged, the charging process can be carried out successfully (at least with a significantly higher probability).

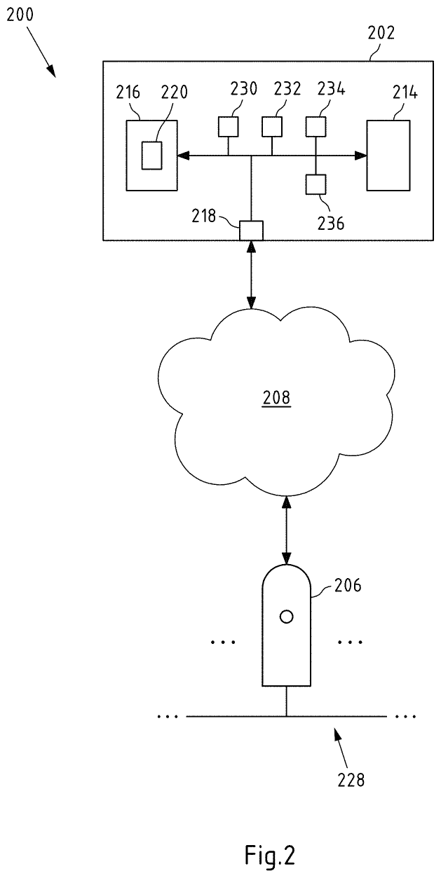

FIG. 2 shows a schematic view of a further embodiment of a charging system 200 according to the present application. To avoid repetitions, essentially only the differences to the embodiment according to FIG. 1 are explained below and otherwise reference is made to the explanations for FIG. 1.

The charging system 200 comprises a plurality of charging stations 206, although only one charging station 206 is shown for a better overview. Furthermore, in addition to the memory module 216 and the charging curve determination module 214, the charging system 200 comprises a recording module 230, an evaluation module 232, a vehicle type determination module 234, and a curve adjustment module 236. Presently, all of these modules 214, 216, 230, 232, 234, 236 are implemented in the backend system 202.

It shall be understood that at least one of these modules may also be (at least partially) arranged and implemented, respectively, in another device, for example, a charging station. In addition, further modules (not shown) may be provided, such as a charging equipment determination module, a timing determination module, etc.

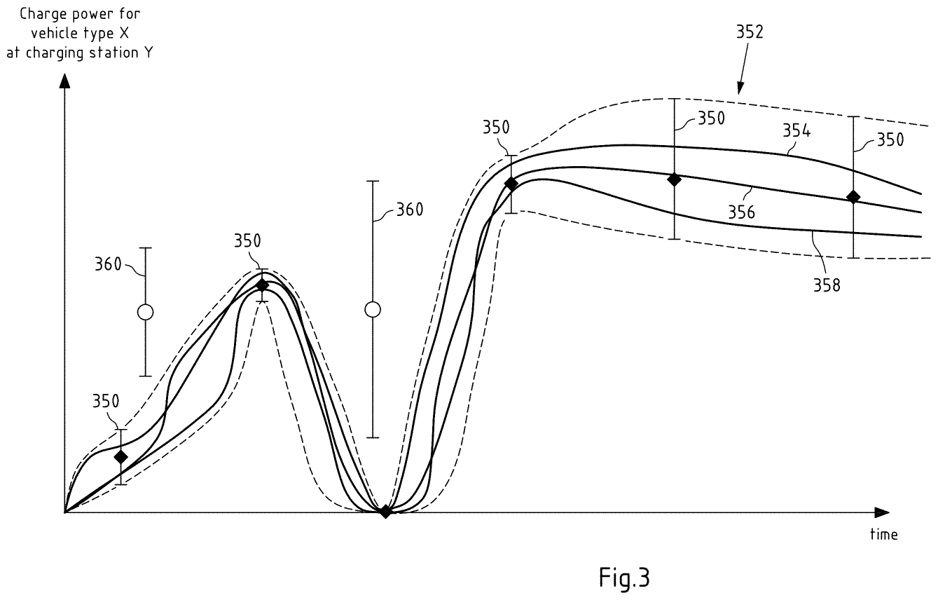

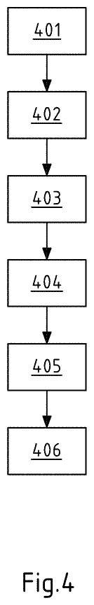

The operation of the charging system 200 is described in more detail below with reference to FIGS. 3 and 4. FIG. 3 shows exemplary charging station position dependent and vehicle type dependent charging curves 354, 356, 358. In particular, on an axis of the diagram the power (can also be voltage and/or current) to be delivered during a charging process at a particular charging station Y when charging an electric vehicle of type X is plotted against time.

In addition, in the present embodiment, a plurality of positive charging station position dependent and vehicle type dependent charging curve characteristics 350 and negative charging station position dependent and vehicle type dependent charging curve characteristics 360 are provided, which are stored, in particular, in the database 220. In particular, in the present embodiment, a plurality of charging curve characteristics are provided in the form of support points 350, 360 and support ranges 350, 360, respectively, defining a positive charging curve range (region) 352 schematically indicated by the dashed lines. In particular, the dashed lines are two positive limit charging curves. It shall be understood that two negative limit charging curves may also be provided. In this case, the boundary charging curves are no longer a part of the positive charging curve region.

In particular, it can be seen that a charging curve 354, 356, 358 to be used and determined by the charging curve determination module 214 must pass through the positive support points 350 and support ranges 350, respectively, while this charging curve 354, 356, 358 must not pass through negative support points 360 and support ranges 360, respectively. In particular, the charging curve determination module 214 may be arranged to generate a charging curve 354, 356, 358 based on the charging station position dependent and vehicle type dependent charging curve characteristics.

FIG. 4 shows an exemplary method for operating the exemplary charging system 200 according to FIG. 2. In a first step 401, it may be detected (in particular, in a conventional manner) that an electric vehicle is to be charged at a charging station 206. Upon such a detection, the charging station 206 may send a previously described request to the backend 202 to request for a charging curve for the charging process.

In the next step 402, the charging curve to be used may be determined. For example, the vehicle type determination module 234 may determine the vehicle type of the vehicle to be charged from at least one indication included in the request (or a further request received via another channel (e.g., from a user terminal of the user)). For example, the indication may be a user identifier that allows the vehicle type determination module 234 to access the user account of the user and/or previous charging events. The user account and/or the previous charging events may comprise vehicle type information. Alternatively or additionally, the information may be a vehicle type information.

Further, the charging curve determination module 214 may determine the charging station location of the charging station 206 at which the charging process is to be carried out. For example, position information, such as a charging station position data set, i.e., a unique indication of the charging station position (e.g., geographic coordinates, such as GPS data, power grid-specific coordinates, etc.), may be contained in the request, or a position information may be derived from a charging station identifier contained in the request. For example, a database may be provided in which all charging station identifiers of the charging system are stored together with the respective charging station position data set and a respective position information, respectively. In one case, the charging station identifier itself may be the position information.

Based on these information pieces (i.e., vehicle type and charging station position), the charging curve determination module 214 accesses and searches, in particular, the database 220 for the charging curve characteristics 350, 360 associated with this vehicle type and this position information. Based on these charging curve characteristics 350, 360, the charging curve determination module 214 may determine, in particular, generate, a charging curve, for example charging curve 356. The generation comprises the creating of the charging curve such that it passes through the determined positive support points 350 and avoids the negative support points.

Optionally, it may be provided that the curve adjustment module 236 adjusts the determined charging curve based on at least one piece of real-time information provided to the curve adjustment module 236. Exemplary and non-exhaustive real-time information that may result in an adjustment and change, respectively, of the charging curve 356 are measured power grid parameters (e.g., power frequency of, for example, the ambient power grid 228, power voltage of, for example, the ambient power grid 228, etc.), meteorological parameters (e.g., ambient temperature of the charging station 206), status information of the connected electric vehicle (e.g., operating temperature), and status information of the charging station 206 (e.g., operating temperature).

This information may be detected by, for example, measurement devices arranged within the charging station or the electric vehicle and transmitted to the curve adjustment module 236. Exemplary adapted charging curves are the charging curves 354 and 358. As can be seen, the adaptation of a charging curve is preferably performed in such a way that the adapted charging curve also lies in the positive charging curve range 352. In other variants, charging curve characteristics for different real-time information values may already be stored in the database.

Subsequently, the determined charging curve, for example, charging curve 358, may be transmitted to the requesting charging station 206. In step 403, the charging process may then be performed using the determined charging curve 358.

Optionally, in step 404, which, in particular, can be performed at least partially in parallel with step 403, the charging process performed in step 403 can be recorded by the recording module 230. This may, for example, allow suitable sensors to record the actually exchanged power curve (and/or current curve, voltage curve, etc.) and transmit this to the recording module 230.

The evaluation module 232 can preferably evaluate the recorded charging process in step 405, which can be performed at least partially in parallel with step 404. In particular, this may comprise a detection of whether the charging process has been successfully performed or whether the charging process has been cancelled.

Depending on the evaluation result, at least one previously described charging curve characteristic may be adapted or created. In particular, in the case of successfully performed charging processes (i.e., in which no cancellation occurred), common (positive) characteristics of the used charging curves (hereinafter referred to as positive characteristics) can be determined in the evaluation and used to generate new support points and/or to adapt already existing support points.

These can then be stored in the database 220 in step 406. In a corresponding manner, cancelled charging processes can be evaluated. Through this, the charging system 200, in particular, the stored charging curve characteristics, can be continuously optimized.

It shall be understood that the determination of the at least one charging curve characteristic can also be based only on the charging station position or on further information, such as the desired charging start time (e.g., detected by a time module), a charging equipment used (e.g., specific charging cable and/or a specific charging adapter).

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1) Charging system for electric vehicles, comprising:
a plurality of charging stations,
at least one memory module at least configured to store charging station position dependent charging curve characteristics, and
at least one charging curve determination module configured to determine a charging curve for charging an electric vehicle connected to a first charging station of the plurality of charging stations based on a position information of the first charging station and the stored charging station position dependent charging curve characteristics.

2. Charging system according to claim 1, wherein
the stored charging curve characteristics are vehicle type dependent, and
the charging curve determination module (114, 214) is configured to determine the charging curve at least based on the vehicle type of the connected electric vehicle (110).

3. Charging system according to claim 1, wherein
at least one charging curve characteristic defines a positive charging curve range,
wherein the charging curve determination module (114, 214) determines the charging curve based on the at least one charging curve characteristic such that the determined charging curve is in the defined positive charging curve range.

4. Charging system according to claim 3, wherein
for defining the positive charging curve range, the at least one charging curve characteristic is a positive support point or a negative support point,
and/or
for defining the positive charging curve range, the at least one charging curve characteristic is a positive limit charging curve or a negative limit charging curve.

5. Charging system according to claim 1, wherein
the charging curve characteristics are stored in a database of the memory module which is searchable at least for a position information.

6. Charging system according claim 1, wherein
the charging system comprises at least one recording module configured to record charging processes performed at the plurality of charging stations, and
the charging system comprises at least one evaluation module, at least configured for a charging station position specific evaluation of the recorded charging processes,
wherein, based on the charging station position specific evaluation, the charging curve characteristics can be stored in the memory module.

7. Charging system according to claim 6, wherein
the evaluation module is configured to detect a successful charging process, wherein, in particular, positive charging curve characteristics are storable into the memory module based on the detection of a successful charging process, and/or
the evaluation module is configured to detect an canceled charging process, wherein, in particular, negative charging curve characteristics are storable into the memory module based on the detection of a cancelled charging process.

8. Charging system according to claim 2, wherein
the charging system comprises at least one vehicle type determination module configured to determine the vehicle type of the electric vehicle connected to the first charging station, based on:
a user identifier and at least one user data set associated with the user identifier,
a user identifier and at least one previous charging data set associated with the user identifier,
a vehicle type information provided by the electric vehicle,
and/or
a vehicle type information input via a user interface module.

9. Charging system according to claim 1, wherein
the stored charging curve characteristics are time dependent, and
the charging curve determination module is configured to determine the charging curve at least based on a charging process start time.

10. Charging system according to claim 1, wherein
the stored charging curve characteristics are dependent on charging equipment used during the charging process, and
the charging curve determination module is configured to determine the charging curve at least based on the charging equipment used during the charging process.

11. Charging system according to claim 1, wherein
the charging system comprises a curve adaptation module configured to adapt a determined charging curve based on at least one real-time information,
wherein the at least one real-time information is selected from the group comprising:
a power grid parameter,
a meteorological parameter,
a status information of the connected electric vehicle,
a status information of the first charging station.

12. Method for operating a charging system, in particular, a charging system according to claim 1, wherein the charging system comprises a plurality of charging stations and at least one memory module in which at least charging station position dependent charging curve characteristics are stored, the method comprising:
determining a charging curve for charging an electric vehicle connected to a first charging station of the plurality of charging stations based at least on position information of the first charging station and the stored charging curve characteristics.
